(19) United States
(12) Patent Application Publication
(10) Pub. No.: US 2014/0278705 A1
(43) Pub. Date: Sep. 18, 2014

(54) Hierarchical Workflow Management System

(71) Applicant: Meyadi, LLC, Irvine, CA (US)

(72) Inventor: Nancy Ellen Tuggle, Newport Beach, CA (US)

(73) Assignee: Meyadi, LLC, Irvine, CA (US)

(21) Appl. No.: 14/298,822

(22) Filed: Jun. 6, 2014

Related U.S. Application Data
(63) Continuation-in-part of application No. 13/705,117, filed on Dec. 4, 2012.
(60) Provisional application No. 61/567,037, filed on Dec. 5, 2011.

(51) Int. Cl. G06Q 10/06

(52) U.S. Cl. CPC G06Q 10/0631
USPC 705/7.23

(57) ABSTRACT

Hierarchical workflow management systems and methods are provided that enable users in the building trades to coordinating workflows for projects having at least three levels.

This application is a continuation-in-part of U.S. patent application Ser. No. 13/705,117 filed on Dec. 4, 2012, published as U.S. publ. no. 2013/0144677, which claims the benefit of U.S. provisional application having Ser. No. 61/567,037 filed on Dec. 5, 2011. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

Systems and methods are provided that enable users in any industry to forecast and monitor project-centric workflow operations in real time, sharply reducing staff, costly delays, and logistical complications. The systems and methods described herein also allows quick determination of any necessary supporting document status, licensing, insurance, payments, responsibilities, and resources, within the hierarchy of companies/entities on the project.

### BACKGROUND

The following description includes information that may be useful in understanding the present invention. It is not an admission that any of the information provided herein is prior art or relevant to the presently claimed invention, or that any publication specifically or implicitly referenced is prior art.

The control and management of large projects involves large sums of investment to depend on the success of relationships and obligations between parties, with each added party increasing the overall complexity of the project and diminishing the probability of success. Failure of costly projects results from a plethora of defects, from poor implementation of legal documentation and project costing procedures, to over-staffing and the inability to project cash flow.

While various software programs are targeted to project management, Applicant is unaware of any software that considers the perspective of all participants on the project (for example: lenders, investors, bankers, developers, producers, property owners, general contractors, subcontractor, suppliers, etc.) and none that address all concerns related to implementation of legal obligations, insurance, licensing documentation, costing procedures, staffing requirements, audit compliance, interest assessment, design and implementation of procedures, resource allocation, assignment of responsibilities, and projection of cash flow, among others. For example, QuickBooks contractor edition, available from Intuit, Inc. of Mountain View, Calif., is strictly financial accounting software and does not address the flow of legal documents nor does it assist in communication and integration of all of the procedures necessary to project management. Certain companies may provide project management software that does address some of the paper flow, but it is very expensive, difficult to use and does not link all aspects of the project together in one comprehensive workflow ensuring that users do not forget an integral part of the process.

### SUMMARY OF THE INVENTION

With increasing scope of projects requiring increasing investment and carrying an increasing risk of failure, systems and methods that provide for clear communication and procedures in the project workflow management trades is desirable.

Accordingly, systems and methods of certain embodiments are provided that enable those in the project workflow management trades to project and monitor project-centric workflow operations in real time, sharply reducing back office staff, costly delays, and logistical complications while allowing each user to utilize project data in a manner specific to their project role.

These systems and methods are applicable to a variety of industries wherein project management is a concern. Some exemplary industries include the construction industry, entertainment industry (concerts, performances, festivals, special events, and the like), hospitality (catering, wedding planning, banquets, conferences, and the like), technical (preparation of prototypes, development of software, product testing, employee training), legal (management of outside counsel and/or clients and vendors), medical (management of patient and insurance information) and the like

The systems and methods of certain embodiments can facilitate validating licenses of contractors and sub-contractors, an otherwise time consuming task. In most states it is illegal to utilize an unlicensed contractor, and the penalties and fines from Worker Compensation for doing so are staggering to a small to mid-size company. Accordingly, systems and methods that enable licenses to be immediately verified with the contractor state license board, for protection, are desirable.

A system and/or method for attaining one or more of the above-referenced objectives are provided. This can include, but is not limited to, fully automated and interactive software for the management of project workflow in any industry, with increased control and instantaneous assessment placed in the hands of banking and lending institutions that service the industry. In a particular application, the interactive software is a visually dynamic and user-friendly system that standardizes and streamlines the creation and transmission of legal and insurance documents, project costing, invoicing and milestone funding between the contractors, sub trades, suppliers and property owners and lending institutions.

There are 10.3 million licensed general and trade contractors in the United States, grossing $789 Billion in revenue for the construction industry. There are also 194 million property owners that have commercial or multi residential properties, and there are also homeowners that want to easily monitor the construction process. Due to the difficulties in securing mortgages for new properties, the market has seen a 20% increase in home remodeling this year alone with projected increases of an additional 16% annually for the next 4 years. These property owners are looking for a way to interface with their contractor and subcontractors while protecting their homes and saving money. CTS can enable these users to achieve one or more of these objectives.

In a first aspect, a method is provided for managing a construction project, comprising: inputting a user's personal data into a contractors trust system, wherein the personal data includes licensing information for a user; inputting project data into the contractors trust system, wherein the project data includes a contract amount; inputting cost information for the project; inputting funding information for the project, wherein the funding information includes approval or declining of an invoice; saving the inputted data; verifying license information with a licensing agency; generating legal documents and automatically submitting them to a preselected party; and graphically displaying estimated costs and actual costs for the project in real time.

In an embodiment of the first aspect, verifying license information further comprises providing the user confirmation of a valid license.

In an embodiment of the first aspect, the method further comprises generating a reminder for renewing a user's license with a licensing board, wherein license information has been entered for the license.

In an embodiment of the first aspect, the method further comprises entering a change order that is immediately incorporated into the estimated costs.

In an embodiment of the first aspect, the method further comprises creating an invoice based on the cost information and automatically submitting a standardized format of the invoice for payment at a preselected time based on the cost information with the necessary conditional lien release (required legal documentation) linked to the invoice in the database.

In an embodiment of the first aspect, the method further comprises submitting an invoice for payment upon approval, whereby automatic electronic payment of the invoice is initiated using financial information included in the personal data.

In a second aspect, a user device is provided comprising: a processor; and a memory adapted to store a plurality of machine-readable instructions which when executed by the processor are adapted to cause the user device to accept input of a user's personal data into a contractors trust system, wherein the personal data includes licensing information for a user; accept input of project data into the contractors trust system, wherein the project data includes a contract amount; accept input of cost information for the project; accept input of funding information for the project, wherein the funding information includes approval or declining of an invoice; save the inputted data; verify license information with a licensing agency; generate legal documents and automatically submit them to a preselected party; and graphically display estimated costs and actual costs for the project in real time.

In an embodiment of the second aspect, the machine-readable instructions when executed by the processor are adapted to further cause providing the user confirmation of a valid license.

In an embodiment of the second aspect, the machine-readable instructions when executed by the processor are adapted to further cause generation of a reminder for renewing a user's license with a licensing board, wherein license information has been entered for the license.

In an embodiment of the second aspect, the machine-readable instructions when executed by the processor are adapted to further cause entry of a change order that is immediately incorporated into the estimated costs.

In an embodiment of the second aspect, the machine-readable instructions when executed by the processor are adapted to further cause creation of an invoice based on the cost information and automatic submission of the invoice for payment at a preselected time based on the cost information.

In an embodiment of the second aspect, the machine-readable instructions when executed by the processor are adapted to further cause submission of an invoice for payment upon approval, whereby automatic electronic payment of the invoice is initiated using financial information included in the personal data.

In a third aspect, a non-transitory computer readable medium is provided having computer readable code for instructing a processor to perform a method, the method comprising: inputting a user's personal data into a contractors trust system, wherein the personal data includes licensing information for a user; inputting project data into the contractors trust system, wherein the project data includes a contract amount; inputting cost information for the project; inputting funding information for the project, wherein the funding information includes approval or declining of an invoice; saving the inputted data; verifying license information with a licensing agency; generating legal documents and automatically submitting them to a preselected party; and graphically displaying estimated costs and actual costs for the project in real time.

In still other embodiments, hierarchical workflow management systems are contemplated that include a project database storing one or more hierarchical structures that each defines at least three hierarchical levels. The project database also stores data sets inputted by users of each hierarchical level, which could include user specifications that define necessary information for a project. The systems can include verification and request engines coupled to the project database. The verification engine can be configured to provide a first interface that enables a user of a first hierarchical level to verify data inputted by one or more users of a second hierarchical level below the first hierarchical level, while the request engine can be configured to provide a second interface that enables a user of a third hierarchical level to request data from one or more users of a fourth hierarchical level above the third hierarchical level. The hierarchical structure can also limit access to the data of other users in a top-down manner, such that higher level users can access the data inputted by the lower level users but not the other way around. Thus, for example, while a user could verify its own data, the hierarchical structure and rules preferably prevents lower level users from accessing/verifying data inputted by higher level users.

Using the contemplated systems and methods, various users of the system (e.g., suppliers, insurers, lenders, contractors, etc.) can be linked via a central database where pertinent information for a project can be stored. Such information could include, for example, project bids, invoices, contractor and subcontractor information (e.g., licensing and insurance information), timelines, workflows, agreements, and so forth. Exemplary systems can monitor different aspects of a project including, insurance and licensing requirements, invoices and payments, agreements and so forth. Preferably, much or all of the monitoring/reporting can occur through automatic workflows, such as those described in more detail below.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 depicts the Highway screen from the General Contractor's view.

FIG. 2 depicts a menu of available screens, including Project Driver, Project Profile, Project Costing, Project Funding, and Doc Dock.

FIG. 3 depicts the Project Driver screen prior to entry of data.

FIG. 4 depicts the Project Driver screen after saving entered data.

FIG. 5 depicts a portion of the Project Driver screen relating to information regarding professional licenses.

FIG. 6 depicts a portion of the Project Driver screen relating to professional references.

FIG. 7 depicts the Project Profile Screen.

FIG. 8 depicts an interface on the Project Profile Screen that enables the user to invite a new user to the project.

FIG. 9 depicts an interface on the Project Profile Screen that enables the user to add an invitee to the project.

FIG. 10 depicts the Project Profile screen after data has been entered and saved.

FIG. 11 depicts the Project Costing screen.

FIG. 12 depicts the Project Funding screen.

FIG. 13 depicts details of the Project Funding screen relating to invoice information.

FIG. 14 depicts the Doc Dock screen.

FIG. 15 depicts a document accessed and displayed via the Doc Dock screen.

FIG. 16 depicts one embodiment of a hierarchical workflow management system.

FIGS. 17-24 depict various embodiments of hierarchical structures having three or more levels.

FIGS. 25-26 depict various embodiments of a project database.

FIGS. 27-28 depict various embodiments of project workflows that across hierarchical levels.

FIGS. 29-30 depict various embodiments of invoice workflows across hierarchical levels.

FIG. 31 depicts a Draw Package screen from the Developer's view.

FIG. 32 depicts a Draw Package screen from the Contractor's view.

FIG. 33 depicts a Highway screen from the Lender's view.

FIG. 34 depicts a Project Profile screen from the Lender's view.

FIG. 35 depicts a Schedule of Value from the Developer's view.

### DETAILED DESCRIPTION

The following description and examples illustrate a preferred embodiment of the present invention in detail. Those of skill in the art will recognize that there are numerous variations and modifications of this invention that are encompassed by its scope. Accordingly, the description of a preferred embodiment should not be deemed to limit the scope of the present invention.

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The Contractors Trust System (CTS) (which could be a hierarchical workflow management system) provides a user the tools to attain a fully automated, interactive and successful project management. By utilizing CTS's clear user friendly features, the flow of information, legal and insurance documents, project costing and milestone funding from the property owner to contractors, sub trades and suppliers is streamlined and automated. This insures that all parties are protected and have a clear understanding of what is required to complete the project on schedule, and within budget. The Project Driver and Project Profile screens are where all pertinent information is entered. This information auto populates the necessary legal and financial documents. As the property owner, a user is asked to invite their contractor and sub trades, who are then able to download the CTS software. As a contractor, a user's license is automatically verified and entered into a nationwide database as a registered user of the CTS system, enabling other users to access the user's licensing information. Tools for easily and accurately following the flow money on a project are one of the advantageous features of CTS. At Project Costing, the system uploads a breakdown of all costs from a user's contractors and populates all invoices, funding and releases. On the Project Tiles, a user is able to monitor all project costs versus the budget in real time. The Doc Dock is where all documents are stored. State specific legal documents required for the user's protection are generated and submitted to the appropriate parties. Clear signals identify what insurance or releases have not been received, and invoicing and funding are made simple based on the milestones funding system. With one click, the user can approve or, if necessary, decline an invoice. Approved invoices are placed on the easy to read calendar, affording contractors the ability to project cash flow. For the contractor user, milestone funding eliminates the problem of delays and the need to make tedious collection calls. By using CTS, all parties involved in a project have a variety of options in which to pay for the project. All banking and personal information are both protected and secure. Funds are electronically transferred by CTS for ease and speed. Upon completion of a project, the user's feedback regarding project participants can be input into a nationwide database of contractors, accessible by other users. CTS an instant messaging tool for the project and the nationwide construction community. CTS can provide advantages compared to other systems. These advantages can include a cost effective solution to project management, the ability to work on multiple projects, construction material discounts, savings on back office staffing for contractors, financial lines of credit and the ability to advertise the user's company nationwide.

By utilizing an easy-to-use and flexible user-friendly interface, CTS automates and stream line the flow of information, legal and insurance documents, project costing and milestone funding between the general contractors, sub trades, suppliers and property owners. Utilizing CTS, all parties are able to protect themselves legally, as well as monitor all project costs, invoice and fund in real time and able the contractors to accurately project cash flow. The system automatically validates the contractor's license, avoiding penalties and fines later on. Each functionality of the CTS software is created with the utmost in simplicity for the user, as well as affordability, building trust for and with the contractor and the construction industry. The CTS manages users, and for each user the system saves user name, password, job title and access level. Access level specifies the user access level to information and actions in the system. Access level can be one of the following: Project administrator, Project Contributor, Reader. Access level for the Contractor is Field, Project Manager, Accounting, Admin, Owner. Access for the Financial Institution is Project Manager, Admin, and Relationship Manager. The user can choose to save his or her user name and password and role after a successful login. The user can choose at any point to logout from CTS.

A user uses a user device to run the CTS software implementing a workflow automation system for use in the construction industry. The CTS is incorporates visually dynamic and user-friendly interface that standardizes and streamlines the creation and transmission of legal and insurance documents, project costing, invoicing and milestone funding between the contractors, sub trades, suppliers and property owners. The system enables monitoring of all project costs, invoicing and funding in real time, projection of cash flow, and validation of licenses of contractors and sub-contractors.

User devices that can be employed to run the CTS can include suitable computing devices, e.g., a personal computer, a smart phone (e.g., iPhone, Google phone, or other phones running Android, Window Mobile, or other operating systems), a tablet computer (e.g., iPad, Galaxy), personal digital assistant (PDA), a notebook computer, or various other types of wireless or wired computing devices. The user device can communicate over a network. The network can be implemented as a single network or a combination of multiple networks. For example, in various embodiments, the network can include the Internet and/or one or more intranets, wireless networks (e.g., cellular, wide area network (WAN), WIFI hot spot, personal area network (PAN), Bluetooth), landline networks and/or other appropriate types of communication networks. As such, in various embodiments, the user device may be associated with a particular link (e.g., a link, such as a URL (Uniform Resource Locator) to an IP (Internet Protocol) address).

The CTS can be provided in different versions. For example, a residential version can be provided, or a full commercial version can be provided. Alternatively, versions can be provided that have state information that accounts for the preliminary lien notice laws of various states and enables the licenses of participating contractors in different states to be verified. The system can provide each party involved in the construction process (e.g., contractor, subcontractor, supplier, customer, etc.) the protection they need during the construction process. The CTS can be provided as a stand-alone system, or as a web based product or cloud computing application. Documentation for operating the system can be provided in any suitable format, e.g., CD, book, or website version.

Customer support can be provided as part of the CTS, e.g., on line or telephone customer support. The customer support can include answering any questions users may have with downloading or features and integration of their accounting or other construction management software into the CTS. Other support can include assisting on financing questions, such as job costing. Features of the CTS that can integrate with customer support can include a job costing “barometer” or “fuel gauge” that allows users to monitor the project costs from their perspective (i.e., owner, general contractor, subcontractor and supplier). A “Milestone System” can be provided that enables monitoring and instituting collections, or a “Net Term” route can be employed such that once invoices have gone out per terms and conditions, emails are generated to confirm receipt, and are continued every two weeks—once terms are passed, collections assistance can be provided if requested. Line of credit assistance can be provided to users (general contractors and sub trades) to insure their payroll is covered through a line of credit, utilizing invoices as collateral.

The CTS can be integrated with QuickBooks financial software, available from Intuit, Inc. of Mountain View, Calif., and Sage Timberline Office Project Management application available from Sage North America of Irvine, Calif. This enables users to use both software programs more effectively.

The CTS offers various functionality available through a user-friendly interface. The main screen of the CTS software, or Project Dashboard, depicted in FIG. 1, provides a menu from which a user can navigate to different screens in software. This menu, situated on the left hand side of the screen and depicted in FIG. 2, includes signs or links to a Project Driver, Project Profile, Project Costing, Project Funding, and Doc Dock. At the Project Dashboard screen, CTS displays a list of projects for the current user. For each project displayed at the dashboard, CTS displays the project's name, state and notifications for events that require the user's attention. The user is able to navigate between his or her projects. Once the user selects one project, the Project Profile screen of the selected project is displayed. CTS provides the user the ability to generate reports on the stored information. Predefined reports include Projects by Start time, and Projects by Actual Cost. The generated report can be saved locally as a PDF, printed or emailed.

A user can select the desired project in several ways, including double-clicking on the sign with the name of the project wanted. Alternatively, a user can scroll the cursor with a mouse and select from a box at the top of the screen by using the arrows next to the box.

Menu navigation can be employed between different screens. The Project Driver screen provides various user information. The Project Profile screen displays details of the project. The Project Costing screen provides cost details. The Project Funding screen provides a schedule detailing the deadlines of the various sub projects involved in a larger project. The Doc Dock screen provides a navigation menu allowing relevant documents to be filled automatically by the CTS.

The Project Driver screen is blank upon opening by a user for the first time, as depicted in FIG. 3. This screen enables the user, here the bank, to input Project and the Borrower's data. Clicking the Save button on the Options bar at the top of the screen causes the input data to be stored by CTS and does not need to be saved again. The saved data can be updated or supplemented, as necessary, and changes saved. An example of a Project Driver screen including saved data is provided in FIG. 4. This data can include a user name, company name, address, city, state, zip code, email address, website, telephone, fax, agent for the user's general liability insurance and email of same, agent for the user's workers compensation and email and funding source of same. Information regarding professional licenses can be entered (FIG. 5), along with professional references (including name, company name, address, phone, and their role) (FIG. 6). The user's company logo, user's photo or other image can also be uploaded.

License information can be validated with the applicable government agencies by clicking the Validate link. The CTS links to the licensing entity's website, or a database containing current licensing information, and verifies the current status of the license information. As depicted in FIG. 5, a green check next to the license information indicates that the license is verified as current and a red X next to the license information indicates that the license was not able to be verified (e.g., lapsed, typographical error in license number, or other issue). For license information not verified as current, the user or customer service provider can investigate further to determine if a data entry issue is responsible for the failure to validate or if the purported licensee is actually not licensed. CTS generates a reminder for each license entered to remind the user to renew his or her license at the state board. The information entered auto populates the necessary legal and financial documents.

As shown in FIG. 7, the Project Profile screen is a screen which has all information about the selected project. This is the screen shown after selecting the project by clicking from a list of saved projects on the Options bar. The information displayed includes the project name, project status, project number, project address, city, state, zip code, client name, owner telephone, project lender, the user role (owner, general contractor, supplier, subcontractor, or other), the start date, the end date, the on-site contact name, the on-site contact telephone number, a general description of the project, and a contract amount (U.S. dollars or other currency). CTS auto generates a project number, and the generated number is unique. This unique number identifies the project in the CTS database. CTS enables a user to invite clients, subcontractors and vendors to download the CTS System or to search the CTS database for their information if they already registered. If one of the invitees has not renewed his or her state license, a notification appears near his or her name. The notification appears near every related screen and document (for example, near a payable for this user). The information entered auto populates the necessary legal and financial documents.

The interface permits invitation of new users by inputting company name, role, and email, as depicted in FIG. 8. The CTS enables the user to order a new user to the project by sending an email request for joining the project. Invitees can be added to a project by clicking between the Registered Users and Invitees displays, as depicted in FIG. 9. A search box is provided to enable searching of registered users and invitees.

The screen, depicted in FIG. 10, appears when the data are reset and the user has filled in data for a project. Data can be saved by clicking a button on the Options toolbar. The data is stored by the CTS and generates a document including the data.

The Project Costing screen, as shown in FIG. 11, provides detailed cost information for companies involved in the project (company name, contract number, amount, and description). For a particular company, details of each separate aspect of the contract are provided, including a description of the work (e.g., demolition, floor, paint, cleaning), the amount, and the date can be accessed by expanding on the company entry. The separate aspects can be individually accepted, declined, or deleted by clicking the applicable button, as shown in FIG. 11. Graphical depictions, similar to a gauge, dial, barometer or meter, depicting the degree of accrual of estimated costs and actual costs are provided adjacent to the company entries, and provide a readily ascertainable snapshot of costing information. Change orders can be incorporated into the overall budget immediately. For each contract, the user can edit a sub data grid where he can enter his: Material, Labor, Rentals, Misc., Sub Total, P&O, and/or the like. CTS automatically sums all the values to a total amount. A Subs Contractors grid is provided where all contracts and schedule values from the sub-contractors are uploaded. For each contract, the user can see the contract number, contract total amount and description. When the user selects a contract, CTS displays a sub grid with the related schedule of values. On the fuel gauge, CTS displays all project costs and the user's budget in real time. CTS enables the user to accept or decline a schedule of value. If accepted, CTS creates an invoice from the schedule of value and update the system with the newly created invoice. The invoice is submitted at the appropriate time. A green notification is shown for both parties at the relevant grid. If declined, a red notification is displayed at both parties at the applicable grid. The information auto populates the necessary legal and financial documents.

The Project Funding screen, depicted in FIG. 12, provides detailed information regarding account status, including invoice information (date issued, company name, due date, invoice number, document status, and amount). The invoice can be accessed to correct and complete entry of information, then accepted or declined by clicking the applicable button, as depicted in FIG. 13. By clicking “Accept”, the invoice is recorded into the appropriate calendar date as listed in the “Due Date”. By clicking “Decline” the record is removed from the table. CTS displays all invoices related to the project and enable the user to accept or decline an invoice. Approved invoices are placed on the easy to read calendar affording contractors the ability to project cash flow and alerting clients as to upcoming expenditures. Declined invoices generate a notification at the owner's CTS system. CTS enables the user to export the invoices to his or her preferred accounting software. Invoice payments can be funded electronically. CTS has the ability to integrate with state local accounting government agencies for funding, permitting and licensing.

The Doc Dock screen, as depicted in FIG. 14, provides an interface allowing the user to access various documents associated with a project by clicking the applicable box. These documents can include contracts, insurances, lien releases, change orders, preliminary notices, project warranties, pictures, and the like. At Doc Dock, CTS enables the user to upload all his or her project related documents. Doc dock functions as a shared folder where all project participants are able to upload documents that are synchronized to all project participants. At Doc Dock, CTS generates the state specific legal documents required for the user's protection and submits them to the appropriate parties. Clear notifications identify what insurance or releases have not been received (red X or yellow exclamation point), and what has been received (green check). These notifications then propagate to the Project Funding screen near invoices related to these documents. The documents stored can be accessed by clicking on the applicable button, which then causes the stored document to be displayed as a pop-up, as shown in FIG. 15.

In certain embodiments, a Tailgate screen is provided that enables the user to rate each service provider he works with. At Tailgate, CTS presents the user with a map, upon which CTS “pins” suppliers (from data stored in the CTS database) that are located within a specified geographic distance from the project's address. In a similar way, the Tailgate map can display other relevant information for the user. In certain embodiments, CTS provides the user with a wizard screen, which enables the user to quickly fill in all mandatory information from the point of view of his or her role on the project. CTS can provide the user online help for the application, or the ability to contact a customer service representative. In certain embodiments, CTS provides the user the ability to save contact information for each participant in his or her projects. The user has the ability to sort the contacts by project, by name or by address. In certain embodiments, CTS can perform one or more of the following functionalities: export invoices to known accounting software; validate license information with each state board; integrate with state local accounting government agencies for funding, permitting and licensing; and interface with internet mapping technology, e.g., Google maps. Entered data is preferably stored in a CTS database, where it is encrypted. All user banking information is preferably associated with a digital signature.

FIG. 16 illustrates one embodiment of a system 1600 for hierarchical management of a workflow. Exemplary workflows are shown in FIGS. 27-28. The system 1600 can include a project database 1610 storing a hierarchical structure 1612 such as any of those shown in FIGS. 17-25, for example, which defines at least three hierarchical levels of users. Project database 1610 can further store data sets 1614 inputted by the users of the at least three hierarchical levels, with access to the data being preferably defined by the hierarchical structure, such that users of a higher hierarchical level having greater privileges or access to the data than those of lower hierarchical levels.

The hierarchical structure 1612 can be further configured with one or more rules such that data inputted by one or more users of one hierarchical level is inaccessible to users below that hierarchical level. To further protect confidential information and limit undesired flow of certain data, the hierarchical structure 1612 could also impose one or more rules to prevent access of a user's data to users of the same hierarchical level, especially where no relationship exists between those users. Thus, for example, looking to FIG. 19, it is contemplated that the level one users could each be prohibited from accessing one another's data. This is important where different users of the same hierarchical level are unrelated. As one example, where the level one users comprise banks or other lenders, each may agree to loan the same level two user money for a project but there is no need for data sharing among the banks/lenders.

System 1600 also includes a verification engine 1620 coupled to the project database 1610, preferably via network 1640, which could comprise, for example, a local network or physical coupling, or one or more wireless networks (e.g., WIFI, cellular, Bluetooth, etc.) or a hybrid thereof. The verification engine 1620 is configured to provide a first interface that enables a user of a first hierarchical level to verify data inputted by one or more users of a second hierarchical level below the first hierarchical level. The second hierarchical level could be immediately below the first hierarchical level or could be two or more levels below. It is also contemplated that the first interface can allow the user of the first hierarchical level to verify data inputted by one or more users of multiple hierarchical levels that are below the hierarchical level of the user. It is further contemplated that the verification engine 1620 could be used to verify a user's own information and/or that information/data of users of the same hierarchical level.

In some contemplated embodiments, the verification engine 1620 is further configured to limit verification of the data inputted by one or more users of the second hierarchical level to users at or above the second hierarchical level. Thus, for example, users of the second hierarchical level could be limited to verifying their own data, as well as data of those users at or below the user's own hierarchical level, and could not verify data of those users of a higher hierarchical level. As a more tangible example, where there are three hierarchical levels comprising a lender/payor, a contractor, and a subcontractor, for example, where the lender/payor is associated with the first hierarchical level, the contractor is associated with the second hierarchical level, and the subcontractor is associated with the third hierarchical level, the contractor could be limited to verifying its own data as well as the data submitted by the subcontractor. In such example, the contractor could not verify data inputted by the lender/payor because such entity is associated with a hierarchical level above the hierarchical level of the contractor. However, the lender/payor could verify the data of the contractor and subcontractor because the lender/payor is associated with a hierarchical level above the hierarchical levels of both the contractor and subcontractor.

In one example, the verification engine could be configured and used to verify licensing or insurance information of a user. It is contemplated that such verification could be performed automatically, such as at set periods of time or after a triggering event (e.g., when the data is submitted to the database), or could alternatively or additionally be performed at the request of a user. It is further contemplated that the verification could comprise submitting a request to a third party entity for verification of the data and/or comparing data from the third party entity to the data submitted by the one or more users. Exemplary third party entities could comprise governmental or licensing bodies, as well as insurance companies, trade organizations, and/or legal representatives. The specific third party entity will likely depend on the information/data to be verified. Thus, for example, licensing information inputted by subcontractors could be automatically verified by the verification engine after being entered, which could comprise a workflow of the verification engine requesting third party data related to the licensing information of that subcontractor, comparing the received third party data with the inputted data, and alerting a user if there is a discrepancy between the two sets of information.

A request engine 1630 can also be coupled to the project database 1610, preferably via network 1640 although other networks could alternatively be used. The request engine 1630 is configured to provide a second interface that enables a user of a third hierarchical level to request data from one or more users of a fourth hierarchical level above the third hierarchical level. As just one example, using the request engine 1630, a user could submit a request for approval of at least one of a request, an invoice, a proposal, an order, and an agreement, although all other documentation requiring approval is contemplated.

It is contemplated that the fourth hierarchical level can be the same as or different than the second hierarchical level described above. In some embodiments, the fourth hierarchical level can be below the second hierarchical level, while in other embodiments, the fourth hierarchical level can be above the second hierarchical level.

The request engine 1630 can be further configured to allow the user of the third hierarchical level to request approval by a user of the fourth hierarchical level, and the grant or deny of a request by the user of the fourth hierarchical level can comprise the data requested by the user of the third hierarchical level. The request engine 1630 could also be configured to allow or enable the user of the third hierarchical level to modify a previously-submitted request.

In still further embodiments, the request engine 1630 is further configured to limit a request of data inputted by one or more users of the third hierarchical level to users at the fourth hierarchical level. In such embodiments, it is contemplated that the fourth hierarchical level is immediately above the third hierarchical level. Thus, for example, in a hierarchical structure having five levels, such as that shown in FIG. 17, a level three user is limited to submitting a request of data inputted by a user of the second hierarchical level and could not submit a request to a user of the first hierarchical level.

System 1600 can optionally include a reporting engine 1650 configured to provide a third interface that enables a user to generate a report in a format based on the hierarchical level of that user. This allows users of each hierarchical level to generate reports of data stored in the project database and perhaps in other databases, which is tailored to that user's requirements based on the user's hierarchical level. This is advantageous because users of each hierarchical level likely have different uses for the requested data and the reports will likely include and/or focus on different sets of data important to that user.

The project database 1610 can be further configured to store one or more user specifications, and the reporting engine 1650 can be configured to automatically analyze data inputted by one or more users, and identify a set of improper data (e.g., missing data, incorrect data, and so forth) by comparing the data to the user specification. The user specification can include a set of rules that define what information is required by that user and the requirements for each field. This could include information such as date of birth and a required format as well as licensing information and a set time period that the entered license should be in force (e.g., not to expire within the next six months).

Thus, for example, a user of a first hierarchical level could use the reporting engine 1650 to analyze data inputted by users of lower hierarchical levels according to the specification submitted by that user. In such embodiment, a contractor or bank's specification could require that data inputted by subcontractors include necessary licensing and insurance requirements, and a report could be generated stating whether the required information has been entered and may even provide the relevant inputted information (e.g., license numbers or copies of proof of insurance). Data inputted could also include a response to a request from another user.

In addition to being able to prepare a traditional report, it is contemplated that the reporting engine 1650 could generate one or more alerts informing the user that information is missing, unintelligible, or otherwise improper (e.g., expired or soon to be expired license or other information), which then allows a user to review the information and either request updated information or modify/update the inputted information. Alerts/reports could also be generated based on an action of a user above or below the user's level. This may include, for example, denial or approval of a request, a request for additional information, a change in status of a request, and so forth.

The reporting engine 1650 could further be used to generate reports or packages of information required by a user. Thus, for example, when requesting a loan or payout of a loan, a developer could generate a report using data stored in the project database 1610, and the report could include pertinent information requested by the lender either manually or via a lender specification stored in the project database 1610. The report/package could include budget information as well as verification that all contractors/subcontractors meet the required licensing and insurance requirements, and that such information is accurate and up-to-date (e.g., not within 30 days of expiring).

Using the system 1600, it is contemplated, for example, that insurance information required for the entire project can automatically be requested according to a user specification of the user requesting the information. Preferably, this is done automatically without requiring specific requests from a user with the system requesting information from those users who have not submitted proof of insurance. Where information is missing, the system 1600, such as via the verification engine 1620, can automatically ping or otherwise request the information missing from that party. Once the information is inputted, it is contemplated that the verification engine 1620 could automatically verify the information.

The reporting engine 1650 can further be used to aggregate various invoices that may be submitted to a user such as those submitted to a contractor by subcontractors, and prepare a single funding request for a higher level user, for example, based on the information previously inputted into the project database 1610.

Using the reporting engine 1650, invoices and other documents can be aggregated by the system 1600, as they are inputted into the project database 1610. Those documents will then appear as a line item on a budget our invoice prepared for a higher level user. However, because all of the documentation is stored on the project database and is linked to within the report, the user can drill down as necessary to understand the line item value or any flag or alert that may appear. Each line item can have one or more “buckets” or options for a user to select. For example, for a specific line item, a user can select a bucket for payment, which may include the options of cash, equity or unpaid. The buckets can also be used to manage other resources including tasks, people, equipment and so forth. Using the system described herein, a user can move resources between different line items or within a line item. As resources are moved, the documentation, if any, associated with the resource remains, and the links/pointers within the report are automatically updated.

System 1600 can manage numerous different workflows including, for example, those related to audit trails, invoices and payments, addition of new rules, legal documentation (e.g., lien releases, preliminary notices, insurance information, license information, title, and so forth), resource allocation (e.g., money, people, equipment, supplies, etc.), notifications, managing responsibilities.

User specifications include prepopulated rules that determine what can be done. Using the user specification, documentation can be generated pertinent to the needs of the user, and related documentation can be updated depending on actions taken.

FIG. 17 illustrates one embodiment of a hierarchical structure 1700 that defines at least three, and here five, hierarchical levels 1710-1750. In this embodiment, level one user(s) 1710 are above level two user(s) 1720, which are above level three user(s) 1730, which are above level four user(s) 1740, which are above level five user(s) 1750. Preferred hierarchical structures are configured such that higher level users have access to their own data as well as data of lower level users, while the data of higher level users is inaccessible to lower level users, unless permission is otherwise granted by the higher level user.

Using the construction industry as an example, a level one user 1710 could comprise a bank, funding source, or other lender, a level two user 1720 could comprise a developer, a level three user 1730 could comprise a general contractor, level four users 1740 could comprise subcontractors, and level five users 1750 could comprise vendors or suppliers of the level four users 1740.

In general, level one users are typically a funding source such as banks, venture capitalists, and insurance companies. Level two users could be owners such as a developer, a home owner, an executive producer, a studio, a hospital or clinic, and a law firm. Level three users could be administrators such as a general contractor, a producer, a hospital or clinic administrator, a law firm administrator, and a managing partner or other management. Level four users could be vendors such as employees, subcontractors (painters, framers, engineers), doctors, nurses, nutritionists, orderlies, public relations, attorneys, and paralegals.

Although shown having a single user for each of hierarchical levels one, two and three, it is contemplated that each of the hierarchical levels could comprises two or more users, which may or may not be related, and which may or may not have access to some or all of the data of the other users of the same level.

FIG. 18 illustrates another embodiment of a hierarchical structure 1800 that defines at least three, and here four hierarchical levels 1810-1840. The four hierarchical levels comprise level one user(s) 1810, level two user(s) 1820, level three user(s) 1830, and level four user(s) 1840. In this embodiment, there are two level one users 1810, which could comprise multiple banks or other lenders who are working with a single level two user 1820, such as a developer, for example. Of course, the specific entities can vary across different industries.

FIG. 19 illustrates another embodiment of a hierarchical structure 1900 that also defines four hierarchical levels 1910-1940. In such embodiment, it is contemplated that data inputted by level one user A is inaccessible to the level one user B of the same hierarchical level.

FIG. 20 illustrates a different hierarchical structure 2000 having five hierarchical levels 2010-2050 that define two distinct sets of level two through five users 2020-2050. Under such structure 2000, the distinct sets of users 2020-2050 are unable to access one another's data. Thus, for example, the data of level two user A is inaccessible to level two user B. This is important where there is no relationship between users of the same or different hierarchical levels, but the users are only connecting by a common user (here, level one user 2010). As an example, the level one user 2010 could comprise a lender/payor who is working with multiple level two users 2020 on entirely different projects, and thus there is no need for data sharing among the various users of the distinct sets or trees.

FIG. 21 provides a specific example of one embodiment of a hierarchical structure 2100 having four hierarchical levels 2110-2140, which could be used in the construction industry. The structure 2100 includes a bank or other lender as a level one user 2110, a developer as a level two user 2120, a general contractor as a level three user 2130, and various subcontractors as level four users 2140. Under such structure, the level four users 2140 are immediately below the level three user 2130, who is immediately below the level two user 2120, who is immediately below the level one user 2110. Of course, the structure could be modified to include two or more users at each level and may or may not allow for data sharing among users of the same hierarchical level.

Under hierarchical structure 2100, the bank could utilize the system to obtain the necessary paperwork required for approval for a loan for a new project. The information for the paperwork can be inputted by the entities involved including the contractors and subcontractors, and once complete, the bank can be alerted. Using the system, the developer could check licensing information of the contractors and subcontractors such as by verifying the information with the appropriate licensing agency. This is preferably done automatically after the licensing information is entered but could also be done at the request of the developer or other party. The developer could further use the system to track the loan status versus equity in the project, add cost estimates or revised submit budgets, and so forth.

FIG. 22 provides a specific example of one embodiment of a hierarchical structure 2200 having four hierarchical levels 2210-2240, which could be used in the entertainment industry. The structure 2200 includes a bank or other lender as a level one user 2210, an executive producer as a level two user 2220, a producer as a level three user 2230, and various subcontractors (e.g., a director, film developer, set design, talent scout, etc.) as level four users 2240. Under such structure, the level four users 2240 are immediately below the level three users 2230, who are immediately below the level two user 2220, who is immediately below the level one user 2210. Again, the structure could be modified to include two or more users at each level and may or may not allow for data sharing among users of the same hierarchical level.

FIG. 23 provides a specific example of one embodiment of a hierarchical structure 2300 having three hierarchical levels 2310-2330, which could be used in the legal industry. The structure 2300 includes a client as a level one user 2310, one or more law firms as level two user(s) 2320, and a vendor, an expert, and an investigator as level three users 2330. Under such structure, the level three users 2330 are immediately below the level two user 2320, who is immediately below the level one user 2310. Again, the structure could be modified to include two or more users at each level and may or may not allow for data sharing among users of the same hierarchical level.

FIG. 24 provides a specific example of one embodiment of a hierarchical structure 2400 having four hierarchical levels 2410-2440, which could be used in the medical field. The structure 2400 includes an insurance company or other payor as a level one user 2410, a hospital as a level two user 2420, doctors as level three users 2430, and laboratories as level four users 2440. Under such structure, the level four users 2440 are immediately below the level three users 2430, who are immediately below the level two user 2420, who is immediately below the level one user 2410. Again, the structure could be modified to include two or more users at each level and may or may not allow for data sharing among users of the same hierarchical level.

FIG. 25 illustrates the central project database 2510, which can be accessible to the various users of the hierarchical structure (here, level one users through level four users 2520-2550). As the various users are likely in different locations, it is preferred that the project database 2510 can be accessible via the Internet or other network(s).

FIG. 26 illustrates another embodiment of a system 2600 for hierarchical management of one or more workflows, such as those described above. System 2600 includes a project database 2610 storing encrypted data 2614 and non-encrypted data 2616. A second database 2612, which could be a partition of the project database 2610 or a distinct database, could be used as a temporary storage location for data requested or inputted by one or more third parties (e.g., outside companies 2630-2634). In this manner, data breaches can be limited to the data stored on the second database 2612, and therefore can avoid exposing the entire data set stored on the project database 2610. One or more firewalls 2620 can be used to detect and prevent unauthorized access of the databases.

FIG. 27 illustrates a simple example of a workflow that can be managed using the systems and methods described herein. Of course, the workflows could be significantly more complex having tens or hundreds of steps, each of which could lead into additional workflows. Using the systems and methods described herein, the workflows advantageously can follow a ping-pong approach where different steps require actions from users of different hierarchical levels. For example, a level four user could submit a request to a level three user, who denies it and send it back to the level four user. The level four user could then modify the request and resubmit it at which point it may be approved by the level three user. A subsequent request can then be prepared either as a function of the previous workflow or at the request of the level three user, and the request could be submitted to a level two user for approval.

The workflow shown in FIG. 27 includes users of two hierarchical levels that are sequential with the first level being immediately above the second level. In step 2700, a level two user could submit an invoice for approval to a level one user. In step 2710, the level one user could review and reject the invoice, which then returns the invoice to the level two user for further editing. At this point, the level two user could be automatically notified of the decision of the level one user to prevent any unnecessary delay. In step 2720, the level two user could modify the invoice and then resubmit the request for approval. The level one user can then be notified of the new request and review the modified invoice. In step 2730, the level one user approves the invoice. This could generate another workflow, for example, that initiates payment of the level two user and/or requests payment from a higher level user.

FIG. 28 illustrates another example of a workflow that can be managed using the systems and methods described herein. The workflow shown in FIG. 28 includes users of two hierarchical levels that are sequential with the first level being immediately above the second level, but could easily include three or more levels of users. In step 2800, a level two user could request acceptance of an agreement. In step 2810, the level one user could review and modify the terms of the agreement and send the agreement to the level two user for review. In step 2820, the level two user could approve the modified agreement and submit a request to the level one user for acceptance of the agreement. In step 2830, the level one user accepts the agreement.

FIG. 29 illustrates an example of an invoice workflow that can be managed using the systems and methods described herein. The workflow shown in FIG. 29 includes a supplier generating and submitting invoices to a subcontractor for approval. The subcontractor then approves the invoices, and generates and submits invoices to the general contractor for approval. The general contractor approves the invoice, which is then dumped into a worksheet containing other approved invoices from one or more subcontractors. The worksheet is sent to the developer for approval. The developer approves the invoices, which are dumped into a developer worksheet containing other approved invoices from one or more general contractors. The developer worksheet is then sent to the funding source, such as a bank, for review. The bank reviews the worksheet containing the approved invoices from one or more developers, and funds the requests.

FIG. 30 illustrates another example of an invoice workflow that can be managed using the systems and methods described herein. The workflow shown in FIG. 30 includes multiple suppliers generating and submitting invoice requests to a subcontractor. The subcontractor then approves the invoices, and generates and submits invoices to the general contractor for approval. The general contractor approves the invoice, which is then dumped into a worksheet containing other approved invoices from one or more subcontractors. The worksheet is sent to the developer for approval. The developer approves the invoices, which are dumped into a developer worksheet containing other approved invoices from one or more general contractors. The developer worksheet is then sent to the funding source, such as a bank, for review. The bank reviews the worksheet containing the approved invoices from one or more developers, and funds the requests.

FIG. 31 is an example of a Draw Package screen for a Developer. The screen includes a list of invoices that are pending approval, as well as invoice information (description for each invoice, amount of the invoice, loan amount for this period, equity amount for this period, original budget, total approved change orders, revised budget, equity amount, loan amount, total loan amount to date, total equity amount to date, percentage complete, and the status of each invoice).

FIG. 32 is an example of a Draw Package screen for a Contractor. The screen includes invoice information (open invoices, draw invoices, soft costs invoices, hard costs invoices, description, company, amount, and document status).

FIG. 33 is an example of a Highway screen for a Lender. The screen includes various projects that the Lender is funding, as well as an indicator for knowing which projects are completed or still in progress.

FIG. 34 is an example of a Project Profile screen for a Lender. After a Lender clicks on a project from the Highway screen, the profile of that project is shown. Various information about the project is listed (name, number, address, owner, lender, insurance, status, etc.).

FIG. 35 is an example of a Schedule of Value screen for a Developer. The screen includes a list of a project's soft costs, including various information on each soft cost (title of soft cost, amount, equity, change order, total contract to date, start date, end date, and status). The Developer has the option to change an order for a soft cost. The screen also includes a Schedule of Value list of subcontractors and suppliers. This list includes a list of clients, and each of the clients has a list of jobs that they have signed on to do. The list of jobs for a client includes various information (description of the job, amount, equity, total change orders, total contract to date, start date, and end date). The Developer also has an option to change an order for a job by a particular subcontractor or supplier.

While the software and methods have been described herein with respect to the construction industry, they are also applicable to other industries wherein project management is a concern. Some exemplary industries include the entertainment industry (concerts, performances, festivals, special events, and the like), hospitality (catering, wedding planning, banquets, conferences, and the like), technical (preparation of prototypes, development of software, product testing, employee training), legal (management of outside counsel and/or clients and vendors), medical (management of patient and insurance information) and the like. The software and methods are especially useful for projects where one or more parties are professionally licensed and/or permits or other documents with government entities are involved. The methods and systems are also well-suited to use in managing projects wherein ease of fund disbursements is desirable, e.g., where many payees are involved.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Application software in accordance with the present disclosure, such as program code and/or data for managing and processing data may be stored on one or more computer readable mediums. It is also contemplated that the application software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that certain features are critical, essential, or even important to the structure or function of the invention, but instead as merely intended to highlight alternative or additional features that may or may not be utilized in a particular embodiment of the invention. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All numbers expressing quantities of ingredients, reaction conditions, and so forth used in the specification are to be understood as being modified in all instances by the term ‘about.’ Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

Although embodiments of the present disclosure have been described, these embodiments illustrate but do not limit the disclosure. It should also be understood that embodiments of the present disclosure should not be limited to these embodiments but that numerous modifications and variations may be made by one of ordinary skill in the art in accordance with the principles of the present disclosure and be included within the spirit and scope of the present disclosure as hereinafter claimed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of coordinating workflow for a project having at least four levels, comprising:
providing an administrator entity with an administrator line item view of information provided by multiple ones of the vendor level entities;
providing an owner entity with an owner line item view of information provided by at least one administrator level entity;
providing a funding entity with a funding line item view of information provided by an owner level entity;
providing interfaces that allow each of the funding, owner, administrator and vendor level entities to (a) add data to a data store, and (b) visualize data from the data store according a set of rules based at least in part on a level of the entity;
automatically consolidating status information and approval requests upwards from the vendor level entities to the administrator entity, to the owner entity, and to the funding entity, wherein deficiencies relating to the status information and approval requests occurring at lower levels are automatically identified to entities at higher levels in their corresponding line item views, and denials of the approval requests are automatically transmitted to appropriate ones of the lower levels.

2. The method of claim 1, wherein the project is one of a construction project, an engineering project, a manufacturing and distribution project, a film project, and a legal project.

3. The method of claim 1, wherein the funding entity comprises a lender.

4. The method of claim 1, wherein the owner entity comprises a developer.

5. The method of claim 1, wherein the administrator entity comprises a general contractor.

6. The method of claim 1, wherein the multiple ones of the vendor level entities comprise subcontractors.

7. The method of claim 1, wherein the data store comprise logically separate confidential and non-confidential data sets.

8. The method of claim 1, wherein the approval requests comprise at least one of an invoice, a resource allocation, and a request to execute an agreement.

9. The method of claim 1, wherein the deficiencies comprise at least one of an expired license, a lack of an insurance certificate, an inaccurate identification number, a lack of a permit, a lack of a proper title, and a lack of a union association.

10. The method of claim 1, further comprising an automatically generated audit trail of status of approval requests.

11. A hierarchical workflow management system, comprising:
a project database storing (a) a hierarchical structure that defines at least three hierarchical levels, and (b) data sets inputted by users of the at least three hierarchical levels;
a verification engine coupled to the project database, and configured to provide a first interface that enables a user of a first hierarchical level to verify data inputted by one or more users of a second hierarchical level below the first hierarchical level; and
a request engine coupled to the project database, and configured to provide a second interface that enables a user of a third hierarchical level to request data from one or more users of a fourth hierarchical level above the third hierarchical level.

12. The system of claim 11, wherein the project database is further configured to store a user specification, and wherein the system further comprises a reporting engine configured to automatically analyze data inputted by one or more users of the second hierarchical level, and identify a set of improper data by comparing the data to the user specification.

13. The system of claim 11, wherein the verification engine is further configured to limit verification of the data inputted by one or more users of the second hierarchical level to users at or above the second hierarchical level.

14. The system of claim 11, wherein the request engine is further configured to limit a request of data inputted by one or more users of the third hierarchical level to users at the fourth hierarchical level.

15. The system of claim 11, wherein data inputted by one or more users of a hierarchical level is inaccessible to user below that hierarchical level.

16. The system of claim 11, wherein the verification engine is further configured to verify licensing or insurance information.

17. The system of claim 16, wherein the second interface is further configured to enable the user of the third hierarchical level to request approval of at least one of a request, an invoice, a proposal, an order, and an agreement.

18. The system of claim 11, wherein the verification engine is further configured to request verification of at least some of the data by a third party entity comprising at least one of a government agency, an insurance company, a trade organization, and a legal representative.

19. The system of claim 11, wherein the verification engine is further configured to verify at least some of the data by comparing at least some of the data to data received from a third party entity.

20. The system of claim 11, further comprising a reporting engine configured to provide a third interface that enables a user of the first hierarchical level to generate a report in a format based on a hierarchical level of the user.
